(19) United States
(12) Patent Application Publication
(10) Pub. No.: US 2015/0063103 A1
(43) Pub. Date: Mar. 5, 2015

(54) BANDWIDTH-DEPENDENT COMPRESSOR FOR ROBUST HEADER COMPRESSION AND METHOD OF USE THEREOF

(71) Applicant: Nvidia Corporation, Santa Clara, CA (US)

(72) Inventors: Bruno De Smet, Sophia Antipolis (FR); Fabien Besson, Sophia Antipolis (FR); Alexander May-Weymann, Sophia Antipolis (FR)

(73) Assignee: Nvidia Corporation, Santa Clara, CA (US)

(21) Appl. No.: 14/017,935

(22) Filed: Sep. 4, 2013

(51) Int. Cl. H04L 12/811; H04L 29/06

(52) U.S. Cl. CPC H04L 47/38; H04L 69/04
USPC 370/230

(57) ABSTRACT

A bandwidth-dependent robust header compression (RoHC) compressor and a method of RoHC. One embodiment of the bandwidth-dependent RoHC compressor is embodied in a protocol stack, including: (1) a bandwidth estimator operable to generate an indicator of excess bandwidth on a channel over which a data flow having original packet headers compressed at an initial compression level is transmitted, and (2) a robust header compression (RoHC) compressor operable to gain access to the indicator and select a reduced compression level based on the indicator.

### TECHNICAL FIELD

This application is directed, in general, to robust header compression (RoHC) of data flows and, more specifically, improving the reliability of those data flows.

### BACKGROUND

Global internet protocol (IP) traffic has quadrupled over the past five years and will likely sustain that pace. Growth in network bandwidth demand could soon outpace the telecommunication industry's ability to deliver. Recent increases in bandwidth demand are due largely to the advent of mobile internet devices, such as smartphones and tablet computers. Compounding the growing number of mobile internet devices, which will soon outnumber the people on Earth, is the fact that video constitutes a majority of the IP traffic. Video streaming consumes significantly larger amounts of bandwidth than typical file sharing and audio.

Bandwidth scarcity is a pressing problem for the telecommunication industry. While some industry players wrestle with the technology to expand network bandwidth, others focus on making existing networks and devices more efficient. RoHC is a standardized method of compressing IP, user datagram protocol (UDP), UDP-Lite, real-time transport protocol (RTP) and transmission control protocol (TCP) headers of internet, or “network packets.” Network packets are formatted units of data transmitted and received over a network. Each packet carries data, which is sometimes referred to as payload or user data, and a header, which contains control data. The header portion of a network packet is essentially the overhead associated with transmitting and receiving that one packet. The control data is necessary for the network to deliver the user data and includes source and destination addresses, error detection data, timestamps and other fields.

RoHC takes advantage of information redundancies in the packet headers by transmitting redundant information once at the beginning of a data flow and only variable information from then on. For example, given a data flow between a source and a destination, the source and destination addresses need only be transmitted once, when the data flow initiates. The bytes allocated to the source and destination addresses are omitted from subsequent packet headers. A RoHC compressor converts the large packet headers into smaller, compressed packet headers before transmission and receipt. A RoHC decompressor at the receiver reconstructs the original packet headers from the received compressed packet headers.

### SUMMARY

One aspect provides a protocol stack. In one embodiment, the protocol stack includes: (1) a bandwidth estimator operable to generate an indicator of excess bandwidth on a channel over which a data flow having original packet headers compressed at an initial compression level is transmitted, and (2) a robust header compression (RoHC) compressor operable to gain access to the indicator and select a reduced compression level based on the indicator.

Another aspect provides a method of RoHC. In one embodiment, the method includes: (1) gaining access to an indicator of excess bandwidth on a channel over which a data flow having original packet headers compressed at an initial compression level is transmittable, (2) selecting a reduced compression level based on the indicator, and (3) compressing the original packet headers at the reduced compression level.

Yet another aspect provides a modem. In one embodiment, the modem includes: (1) a transceiver operable to transmit and receive packets of a data flow over a channel, the packets having packet headers compressed at an initial compression level, and (2) a protocol stack having: (2a) a bandwidth estimator configured to assess the channel and identify excess bandwidth, and (2b) a RoHC compressor configured to select a reduced compression level based on the excess bandwidth and apply the reduced compression level to the packet headers.

### BRIEF DESCRIPTION

Reference is now made to the following descriptions taken in conjunction with the accompanying drawings, in which:

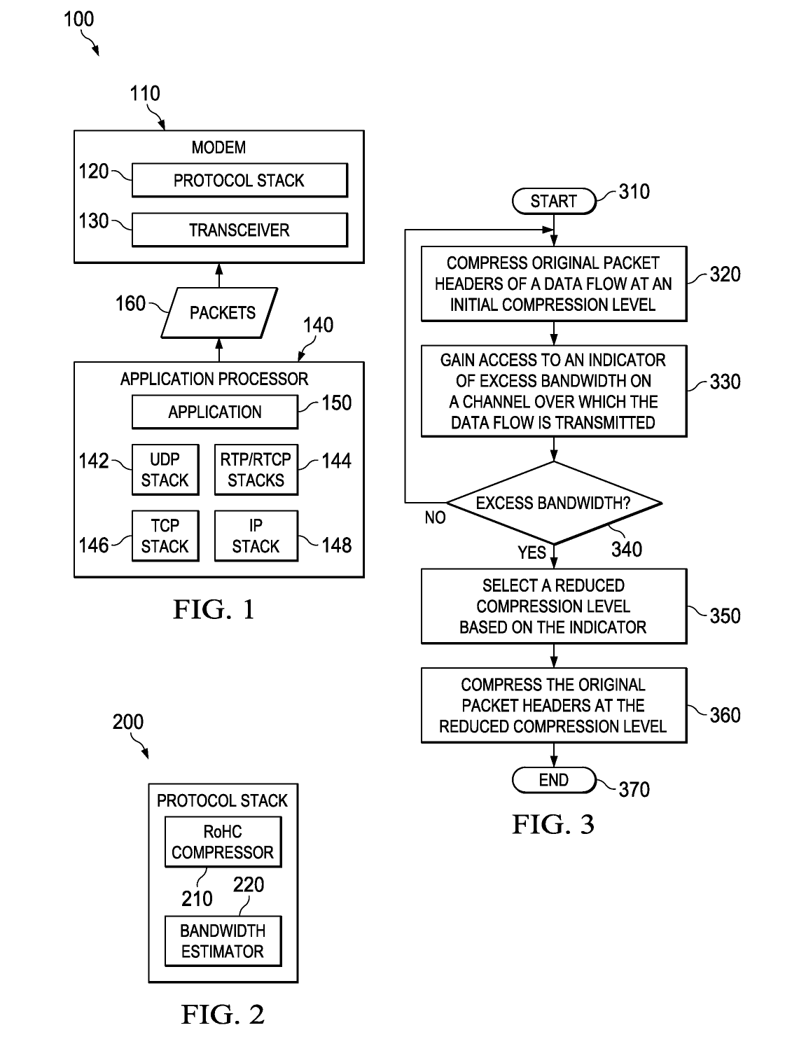

FIG. 1 is a block diagram of one embodiment of a system capable of bandwidth-dependent RoHC;

FIG. 2 is a block diagram of one embodiment of a protocol stack capable of bandwidth-dependent RoHC; and

FIG. 3 is a flow diagram of one embodiment of a method of RoHC.

### DETAILED DESCRIPTION

RoHC is designed to reduce the size of packet headers in a data flow by removing redundant data between consecutive packets. Under normal operation, a RoHC decompressor can reconstruct the original packet headers without any data loss. In the event the original packet headers cannot be reconstructed, possibly due to packet loss or bit errors in the transmission, the RoHC decompressor initiates negative feedback to the transmitting compressor. The RoHC compressor would then reduce the compression level to increase the size of the compressed packet headers, thus retaining some data redundancies. The compression level is reduced until successful decompression is achieved on the receiving end. The larger compressed packet headers are more reliable than smaller compressed headers because transmission losses are more easily recoverable if each packet header contains a portion of the non-variable packet header data.

A RoHC compressor typically seeks the highest level of compression a channel supports. This results in the smallest possible compressed header with just enough information for the decompressor to reconstruct the original packet header from the previously received packet header. Determining this maximum compression level supportable by the channel typically involves employing acknowledge and negative acknowledge messages (ACKs and NACKs) sent by the decompressor at the receiver. The RoHC compressor generally increases the compression level when receiving ACKs, which decreases the size of the compressed header and improves compression efficiency, and reduces the compression level when receiving NACKs, which increases the size of the compressed header and reduces the compression efficiency. The precise employment of the ACKs and NACKs varies among implementations. Certain implementations may require several NACKs over a time period before reducing the compression level. Others may require even fewer before increasing the compression level.

It is realized herein that the maximum compression level supportable by the channel is not always necessary. It is occasionally the case that excess bandwidth exists on the channel. In that case, it is realized herein that, the RoHC compressor can select a reduced compression level to improve the reliability of the data flow. It is further realized herein that the compressor may use a variety of bandwidth criterion to refine the selection of the compression level. Bandwidth criteria include lost packet counts, variance in packet transmission delay, transmission times for test data flows and several others. A modem, or the protocol stacks implemented within the modem, often implements a variety of bandwidth estimation utilities for normal operation, such as determining bit rates, frame rates or other parameters that are controlled according to available bandwidth. It is also realized herein that the RoHC compressor can gain access to an indicator of excess bandwidth and employ that indicator in making the compression level decision.

Before describing several embodiments of the bandwidth-dependent RoHC introduced herein, a system within which bandwidth-dependent RoHC can be implemented will be described.

FIG. 1 is a block diagram of a system 100 within which bandwidth-dependent RoHC can be implemented. System 100 includes a modem 110 and an application processor 140. Application processor executes an application 150 and generates packets 160 that are passed along to modem 110 for transmission.

Application processor 140 is operable to execute an application 150 that generates the payload data for a data flow. Certain embodiments of application processor 140 include an encoder for encoding raw data streams from application 150 before being packetized and transmitted. For example, applications that generate video streams often utilize an H.264 or MPEG-4 AVC encoder. Audio streams may use an MPEG-4 or MP3 encoder, among many others. Examples for voice applications include encoders such as SVOPC, which is used by Skype®, or ITU standard G.722.2, which is mentioned in the 3^{rd} Generation Partnership Program (3GPP) standard and sometimes referred to as AMR-WB.

Additionally, a UDP stack 142, RTP/RTCP stacks 144, a TCP stack 146 and an IP stack 148 are implemented on application processor 140. Within application processor 140, application 150 generates the data and invokes the appropriate encoder and stack. For example, a typical data sharing application may utilize TCP stack 146. TCP is often used in web browser, email and file transfer applications. Another example is a video teleconference application that utilizes RTP/RTCP stacks 144. RTP is well suited for carrying video and audio streams and is commonly used in streaming media applications such as telephony, video teleconferencing, television services and push-to-talk applications. A well-known example of these applications is voice-over-IP (VOIP).

Application processor 140 executes application 150, thereby generating data and initiating the data flow. The data generated by application 150 includes control data and payload data. The appropriate stack packetizes the payload data and control data into packets 160.

Modem 110 includes a protocol stack 120 that implements RoHC among many other modules, and a transceiver 130. Modem 110 can include a variety of protocol stacks, such as a 3GPP stack that implements RoHC. Modem 110 receives packets 160 and prepares them for transmission via transceiver 130 over a medium, such as a wireless, wired or optical network. Protocol stack 120 processes packets 160 by initially assigning a CID to the data flow and compressing the packet headers. Compression is achieved by transmitting the differences between a current packet and a previous packet. Depending on the level of compression, certain levels of redundancy between successive packets is left in the packet headers to improve reliability of the data flow. Ideally, the most efficient RoHC transmits only the deltas between consecutive packet headers. Practically, a typical RoHC compressor uses the maximum compression level supportable by the channel, which is often below the ideal compression level, due at least in part to lossy transmissions. Compressed packets are then passed to transceiver 130 for transmission. Transceiver 130 is configured to transmit packets and receive feedback in the form of ACKs and NACKs, which are passed back to protocol stack 120.

Having described a system within which a bandwidth-dependent RoHC compressor and method of RoHC introduced herein may be embodied or carried out, several embodiments of the bandwidth-dependent RoHC compressor and method of RoHC will be described.

FIG. 2 is a block diagram of one embodiment of a protocol stack 200. Protocol stack 200 includes a RoHC compressor 210 and a bandwidth estimator 220, and is operable to recognize and utilize excess bandwidth by reducing the RoHC compression level for a data flow to improve the reliability of that data flow. Bandwidth estimator 220 employs a variety of bandwidth assessment utilities to determine if excess bandwidth exists on a channel over which the data flow is transmitted. Bandwidth assessment utilities include packet loss counters, packet-to-packet latency variance, test data flows and others. Once bandwidth estimator 220 determines if excess bandwidth exists, an indicator is made available to RoHC compressor 210.

RoHC compressor 210 receives packets of a data flow and processes them by compressing the packet headers at an initial compression level. The compressed packets are then transmitted over the channel. RoHC compressor 210 then gains access to the indicator (of excess bandwidth) and employs it in selecting a new compression level for the data flow. If excess bandwidth exists, a reduced compression level is selected that will improve the reliability of the data flow. If no excess bandwidth exists, the compression level may either be maintained or increased to free up bandwidth on the channel.

FIG. 3 is a flow diagram of one embodiment of a method of RoHC. The method begins in a start step 310. In an initial compression step 320 the original packet headers of a data flow are compressed at an initial compression level. The compressed packet headers are then transmitted over a channel. If excess bandwidth exists on the channel, an indicator is set to reflect that excess bandwidth. Access to the indicator is gained in a bandwidth estimation step 330. In a decision step 340, the method either maintains the original compression level, returning to initial compression step 320 if no excess bandwidth exists, or a reduced compression level is selected in a selection step 350 if excess bandwidth exists. Decision step 340 is based on the indicator made available at bandwidth estimation step 330. Once a reduced compression level is selected based on the indicator, the method proceeds to a reduced compression step 360 where the original packet headers of the data flow are compressed at the new, reduced compression level selected at selection step 350. The method then ends in an end step 370.

Those skilled in the art to which this application relates will appreciate that other and further additions, deletions, substitutions and modifications may be made to the described embodiments.

What is claimed is:

1. A protocol stack, comprising:
a bandwidth estimator operable to generate an indicator of excess bandwidth on a channel over which a data flow having original packet headers compressed at an initial compression level is transmitted; and
a robust header compression (RoHC) compressor operable to gain access to said indicator and select a reduced compression level based on said indicator.

2. The protocol stack recited in claim 1 wherein said RoHC compressor is further operable to compress said original packet headers at said reduced compression level.

3. The protocol stack recited in claim 1 wherein said RoHC compressor is further operable to employ feedback from a RoHC decompressor that receives said data flow to select said reduced compression level.

4. The protocol stack recited in claim 3 wherein said feedback includes acknowledge and negative acknowledge messages (ACKs and NACKs).

5. The protocol stack recited in claim 1 wherein said reduced compression level is below the maximum compression level supportable by said channel.

6. The protocol stack recited in claim 1 wherein said reduced compression level is operable to yield larger compressed packet headers than said initial compression level.

7. The protocol stack recited in claim 6 wherein said larger compressed packet headers are sufficient for a RoHC decompressor to reconstruct said original packet headers.

8. A method of robust header compression (RoHC), comprising:
gaining access to an indicator of excess bandwidth on a channel over which a data flow having original packet headers compressed at an initial compression level is transmittable;
selecting a reduced compression level based on said indicator; and
compressing said original packet headers at said reduced compression level.

9. The method recited in claim 8 further comprising assessing said channel's bandwidth and estimating said excess bandwidth.

10. The method recited in claim 8 further comprising transmitting said data flow toward a receiver having a RoHC decompressor.

11. The method recited in claim 10 further comprising decompressing and reconstructing said packet headers.

12. The method recited in claim 10 wherein said initial compression level is a maximum compression level supportable by said channel that provides sufficient data to said RoHC decompressor to reconstruct said original packet headers from previously received packet headers.

13. The method recited in claim 10 further comprising receiving acknowledge and negative acknowledge messages (ACKs and NACKs) indicative of successful reconstruction of said original packet headers from said RoHC decompressor.

14. The method recited in claim 8 wherein said selecting includes employing observed packet loss to determine said reduced compression level.

15. A modem, comprising:
a transceiver operable to transmit and receive packets of a data flow over a channel, said packets having packet headers compressed at an initial compression level; and
a protocol stack having:
a bandwidth estimator configured to assess said channel and identify excess bandwidth, and
a robust header compression (RoHC) compressor configured to select a reduced compression level based on said excess bandwidth and apply said reduced compression level to said packet headers.

16. The modem recited in claim 15 wherein said protocol stack includes a RoHC decompressor configured to decompress and reconstruct received packet headers from said channel.

17. The modem recited in claim 15 wherein said protocol stack is a 3^{rd} Generation Partnership Project (3GPP) stack.

18. The modem recited in claim 15 wherein said RoHC compressor is further configured to employ a maximum supportable compression level if said excess bandwidth does not exist on said channel.

19. The modem recited in claim 15 wherein said data flow is a transmission control protocol (TCP) data flow.

20. The modem recited in claim 15 wherein said data flow is a user datagram protocol (UDP) data flow.
